(19) United States
(12) Patent Application Publication
(10) Pub. No.: US 2013/0076024 A1
(43) Pub. Date: Mar. 28, 2013

(54) HOSE COUPLING WITH A NON-SWAGED PORTION

(71) Applicants: Mark Allan Lamontia, Landenberg, PA (US); Yu Xu, Wilmington, DE (US)

(72) Inventors: Mark Allan Lamontia, Landenberg, PA (US); Yu Xu, Wilmington, DE (US)

(73) Assignee: E I DU PONT DE NEMOURS AND COMPANY, Wilmington, DE (US)

(21) Appl. No.: 13/627,193

(22) Filed: Sep. 26, 2012

Related U.S. Application Data
(60) Provisional application No. 61/539,043, filed on Sep. 26, 2011.

(51) Int. Cl. F16L 33/00

(52) U.S. Cl. 285/256

(57) ABSTRACT

An umbilical hose end coupling that comprises a sleeve and an insert for the sleeve, the insert having a hose end for insertion into the hose and the sleeve having a hose end for covering the exterior of the hose and the insert, and the insert and sleeve each having a coupling end for engaging each other, and the sleeve having a first specified region that is subject to swaging and a second specified region that is not subject to swaging.

### BACKGROUND OF THE INVENTION

1. Field of the Invention

This invention relates to an improved hose coupling that is useful with textile-reinforced hoses employed in the oil and gas industry, especially high-pressure thermoplastic hoses for use in offshore systems.

2. Description of the Related Art

The petroleum industry works to extract oil using offshore platforms. Oil platforms are connected to the sea floor with, among other items, reinforced hoses that are capable of withstanding large internal pressures, as well as the high external pressure from the seawater at very great depths. Some hoses have a thermoplastic polymer inner layer referred to as a liner and with fiber reinforcements around that the liner. Those layers are collectively encased by a polymer cover that is typically abrasion resistant.

With the need to withstand increased pressures, candidate hoses are burst tested to see if they will work acceptably. Many hose end couplings can not meet the burst pressure requirement. For example, in a burst test, a nominally 1000 mm long hose is hung from the end coupling and pressurized. If the operating pressure requirement is 7,500 psi, then the hose system must sustain 30,000 psi (factor of safety=4) without burst. It must additionally withstand a cyclic pressure of 10,000 psi for 400,000 cycles without failing.
In the test, there are three potential main failure modes.
1. Failure of the hose away from the end couplings.
2. Failure of the fiber reinforcement in or near the end coupling.
3. Failure wherein the end coupling becomes disconnected from the hose.

Many hose failures occur in the fiber reinforcement at the hose area of the couplings and the hoses never reach their potential service life.

For hoses of the type under consideration, the coupling is swaged or crimped before being placed in service to provide the required connection of the hose and coupling. For the purposes herein, the words crimped and swaged are used interchangeably to mean the sleeve is radially pressed or compressed onto the hose and insert. However, the term “swaged” will be used primarily. For the purposes herein, the end where the sleeve and insert engage each other is called the coupling end while the end terminating at the hose is called the hose end.

### BRIEF DESCRIPTION OF THE DRAWINGS

FIG. 1 is a longitudinal view of a precursor coupling sleeve before it is formed into final shape.

FIG. 2 is a graph that is directed to the iterative process for determining the shape of the sleeve

FIG. 3A is a longitudinal view of a coupling in its pre-swaged form.

FIGS. 3B-3D are longitudinal views of a coupling as it is progressively swaged.

### DETAILED DESCRIPTION OF THE INVENTION

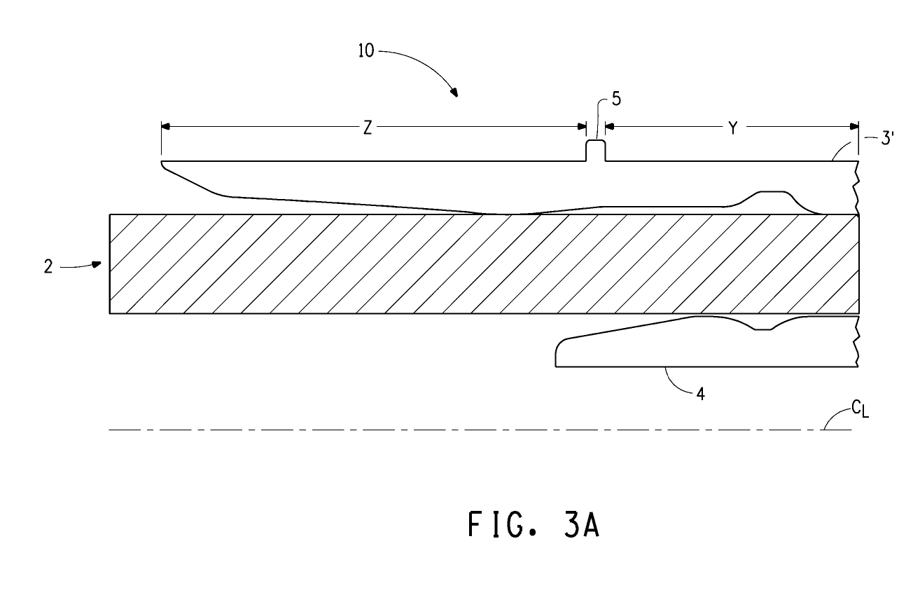

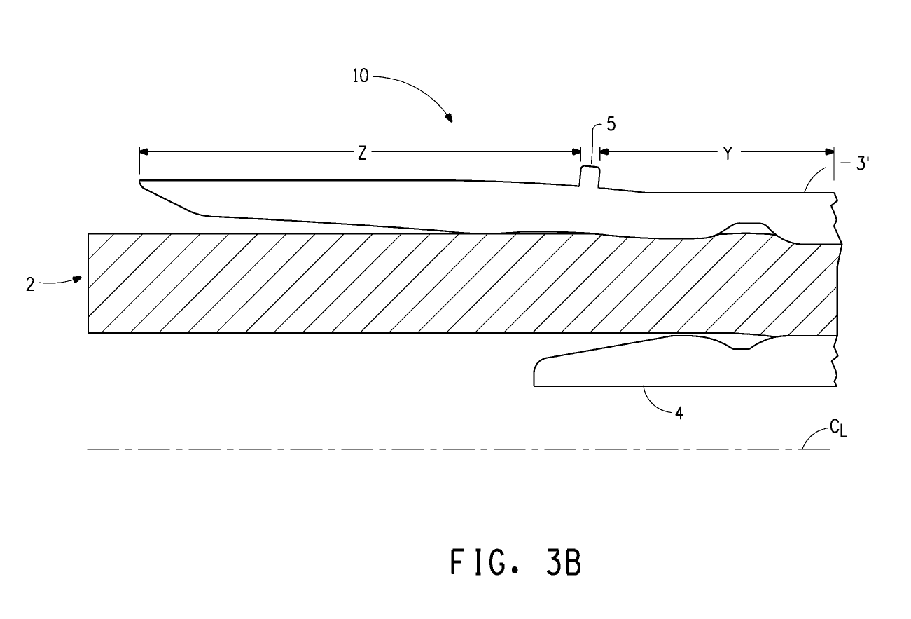

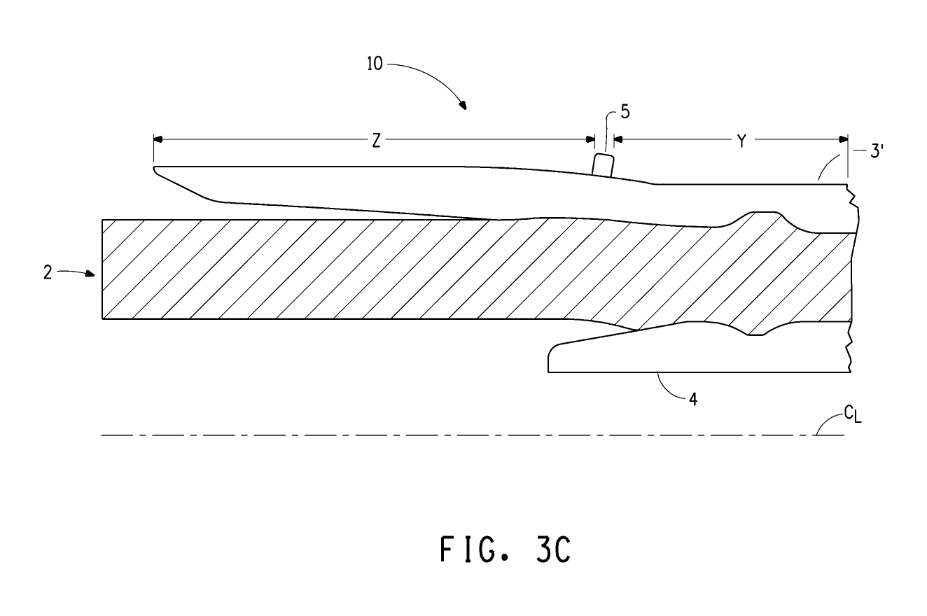

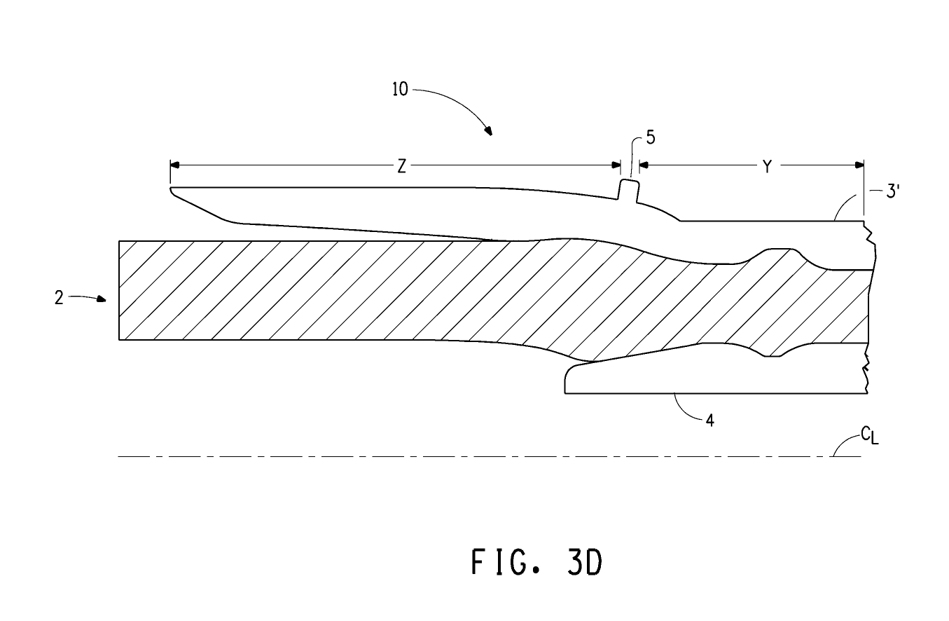

This invention relates to an improved hose coupling that is useful with high pressure textile-reinforced hoses in the oil and gas industry. It is desirable to obtain a hose coupling as depicted in FIG. 3A. The coupling 10 typically comprises a sleeve 3′ with an insert 4. Hoses 2 tend to be circular and, as such, so would the sleeve and insert; but other shapes are not foreclosed. The incidence of failure can be reduced if the hose can be gripped by the coupling sleeve in a manner such that the load is gradually spread over a greater length.

To achieve the desired shape and to further achieve a better connection between the hose and the coupling it has been found desirable to utilize a coupling that is selectively swaged in that a first portion of the sleeve would be subject to swaging and a second portion would not be swaged, as indicated for example in FIG. 1 by Y and Z, respectively. The swaging or crimping may only be applied to area Y whereas; no (or substantially no) swaging is applied to area Z. Further, there is a nub 5 or some other suitable indicator to differentiate where the swaging should be performed. However, the geometry of the coupling, more specifically the sleeve, must be established, so that the swaging process places the coupling and hose assembly in a form for actual use with the desired properties.

In order to explain this further, consider a coupling that was already in the desired shape (such as depicted in FIG. 4) immediately before the final swaging operation. The hose 2 which is typically comprised of a cover, reinforcement and liner, (but for convenience is not shown here) could not be inserted into the coupling, as the insert would be too small. The insert must initially have a significantly increased diameter in order to allow for the hose insertion with subsequent crimping or swaging, and finally, closure over the hose. It is readily seen that the initial shape and the crimping or swaging parameters must be highly specified in order to achieve the desired final shape.

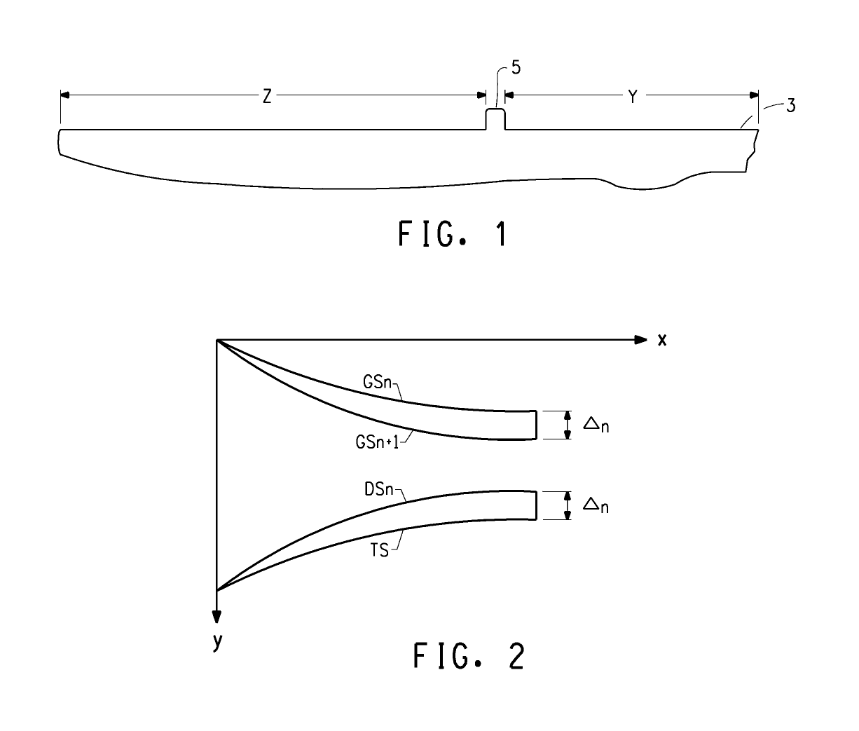

Initially, a desired inner surface shape of the sleeve must be determined. Determining the inner surface shape of the sleeve that eventually achieves the desired shape requires some analysis. A systematic way of finding the pre-deformed sleeve inner surface shape that will be formed into the desired shape after swaging or crimping is essential in implementing the invention. As such, an iterative approach has been developed to find such a pre-swaged sleeve inner surface shape based on finite element modeling. The iterative approach is as follows:
Step 1: Choose an approximation to the final shape as the initial shape. Determine an initial configuration based on the pre-swaged sleeve inner surface shape: GSₙ (n=0) as presented in FIG. 2
Step 2: Simulate the swaging or crimping process of the end coupling using finite element modeling to obtain the swaged sleeve inner surface shape: DSₙ as would be shown in FIG. 2 for example. This would give a deformed shape of the insert surface, however, it should be noted that the figure does not show the actual detail of the surface.
Step 3: Compare the calculated surface with the desired surface and subtract the surfaces to generate a difference as a function of axial length along the insert. Adjust the length of the transition zone; plot the desired sleeve inner surface shape denoted as the target shape TS, and formed shape DSₙ as functions of the axial length as shown in FIG. 2; compute the difference between the target shape and the formed shape Δₙ=(TS−DSₙ) as illustrated.
Step 4: Combine the initial approximation and the difference function by subtraction to the initial shape from Step 1. If Δₙ values are smaller than an established tolerance, then the estimated GSn is the pre-deformed sleeve shape for which we are seeking because it will be formed into the target shape within the tolerance and the iterative process stops. Otherwise, generate a new estimate for the pre-deformed sleeve inner surface shape according to the formula: GSₙ₊₁=GSₙ+Δₙ as illustrated.
Step 5: Increase n by 1 and go to step 2 and iterate until the final crimped or swaged shape equals the desired shape within a chosen tolerance.

FIGS. 3B-3D depict the coupling being progressively swaged at portion Y. As shown in the figures, after swaging is completed, unswaged portion Z of the sleeve also changes shape considerably as a result of the material flow from directly swaging portion Y. It should be noted that although the coupling has an extended sleeve flange, it is not a requirement that the flange extends past the insert into the hose region and over the hose as depicted.

What is claimed is:

1. A hose coupling adapted for use with a hose, comprising:
a sleeve and an insert, wherein a first portion of the sleeve is swaged and a second portion is not swaged.

2. A process for making a hose coupling adapted for use with a hose, comprising:
providing a hose and a hose coupling having a sleeve and an insert, wherein the sleeve has a designated first portion and a designated second portion
progressively swaging in a series of steps the first portion of the sleeve until a final swaged hose and hose coupling assembly is formed.
